(19) United States
(12) Patent Application Publication
(10) Pub. No.: US 2023/0301291 A1
(43) Pub. Date: Sep. 28, 2023

(54) INSECT STICKY TRAP WITH CORRUGATED SURFACE

(71) Applicant: Sterling International, Inc., Spokane, WA (US)

(72) Inventors: Qing-He Zhang, Greenacres, WA (US); Rodney G. Schneidmiller, Greenacres, WA (US)

(21) Appl. No.: 18/126,354

(22) Filed: Mar. 24, 2023

Related U.S. Application Data
(60) Provisional application No. 63/323,230, filed on Mar. 24, 2022.
(60) Provisional application No. 63/389,215, filed on Jul. 14, 2022.

(51) Int. Cl. A01M 1/16; B32B 3/28; B32B 1/00; B32B 7/12

(52) U.S. Cl. CPC A01M 1/16; B32B 3/28; B32B 1/00; B32B 7/12; B32B 29/08

(57) ABSTRACT

An adhesive trap for entrapping pests such as insects such as flying or crawling insects, or other small creatures includes a corrugated panel defining a plurality of channels connected by convex peaks. For example, the corrugated panel, or a plurality of corrugated panels, may be configured and/or assembled to define a pillar or the like. A pressure sensitive adhesive is adhered only in the plurality of channels, such that the convex peaks of the corrugated panel are free of adhesive. The adhesive trap is effective at capturing target insects, and the adhesive-free outer portions facilitate handling of the traps without contacting the adhesive and reduces the risk and likelihood of inadvertently ensnaring or adhesively engaging larger, non-target creatures.

### CROSS-REFERENCE(S) TO RELATED APPLICATION(S)

This application claims the benefit of U.S. Prov. Patent Appl. No. 63/323,230, filed Mar. 24, 2022, and claims the benefit of U.S. Prov. Pat. Appl. No. 63/389,215, filed Jul. 14, 2022. The entire disclosures of said applications are hereby incorporated by reference in their entireties.

### BACKGROUND

Insects of the order Diptera, sometimes referred to as “true flies,” including house flies, horse flies, stable flies, bottle flies, flesh flies, black flies, sand flies, and mosquitoes, are often significant disease vectors, nuisances, and pests. For example, the house fly, Musca domestica L. (Diptera: Muscidae), is one of the most important hygiene pests worldwide. True flies are not only a nuisance, irritating people and animals and leaving regurgitation and fecal spots on surfaces, but they are also vectors of pathogens that may cause serious diseases in humans and animals.

Similarly, insects of the order Hymenoptera, which include flying insects such as sawflies, social wasps, and bees, are also significant nuisances and pests. Social wasps, including paper wasps, hornets, and yellowjackets, are a significant hazard to people and animals engaged in outdoor activities due to their painful and potentially deadly stings. Such flying insects can be prevalent in rural settings and in very well-developed residential areas. Pestiferous insects from other orders, flying and otherwise, are also known, for example in agricultural and greenhouse settings and in other commercial venues, including, for example, meat packing factories, food processing facilities, and livestock ranches.

Significant efforts are directed to combating the problems caused by pest insects, including the use of chemical control means such as pesticides, which may be annoying and/or harmful to persons or non-target animals. Many insects such as house flies and the like have developed resistance against commonly used insecticides due to typically high reproductive rates. Moreover, insecticides that are effective against pestiferous insects may not be an attractive option to persons having concerns regarding personal health effects, environmental effects, and the like.

As a part of environmentally sound pest control strategies, insect traps baited with benign semiochemicals and/or with visual attractants (for flying or walking insects) have been quite successful at attracting and trapping target insects and are known in the art. See, for example, U.S. Pat. No. 9,015,988 to Zhang et al., which is hereby incorporated by reference.

Insect traps that use an adhesive to capture flying insects, for example fly paper, fly strips, and fly ribbons, are well-known in the art, and are sometimes referred to conventionally as “sticky traps”. Insect traps that use an adhesive to entrap insects have obvious safety and environmental advantages, for example they do not require the use or widespread application of toxic chemicals. For example, certain adhesive traps commonly referred to as “yellow sticky cards” (also called “yellow sticky traps”), are well known adhesive traps for combatting damaging insects, and are typically an important part of an Integrated Pest Management (IPM) program in agricultural settings. Yellow sticky cards are widely used for monitoring and/or mass-trapping target pest insects such as fruit flies, fungus gnats, whiteflies, aphids, leaf miners, thrips, psyllids, leafhoppers, buprestid beetles, etc., in both greenhouses and field crops. A cylindrical pillar device that is suitable for use as a sticky trap is disclosed in U.S. Pat. No. D700,269 to Chapin et al., issued on Feb. 25, 2014. Such adhesive traps are suitable for catching various flying insects including, for example, pestiferous social wasps, carpenter bees, biting flies, and nuisance flies.

Typically, sticky traps are coated with adhesive covering all or a portion of planar surface of the trap. The adhesive is exposed for entrapping insects that crawl, walk, alight or otherwise engage the adhesive surface. Although adhesive strips, sticky cards or pillar/stick traps have found success, a risk associated with traps that rely on an exposed adhesive to entrap flying insects is that nontarget species, including for example, birds, bats or other small animals, may inadvertently become ensnared by the adhesive, which can result in injury to the nontarget species and/or destruction of the trap. The exposed sticky surfaces may also create an annoyance to users, for example by transferring adhesive onto a user's hands/fingers or gloves when handling the traps, or adhering to clothing, tools, or other implements.

Prior art solutions for reducing the entanglement of nontarget species with adhesive traps have had some success, for example pillar/stick traps available under the Rescue® and TrapStik® trademarks for flies, wasps, and carpenter bees may be provided with fence-type guards. See, for example, U.S. Pat. No. D831,782, issued on Oct. 23, 20218; U.S. Pat. No. D846,059, issued on Apr. 16, 2019; U.S. Pat. No. D873,949, issued on Jan. 28, 2020; U.S. Pat. No. D915,544, issued on Apr. 6, 2021; and U.S. Pat. No. 10,980,224, issued on Apr. 20, 2021, which are hereby incorporated by reference. Adhesive traps with bird guards have had significant success in reducing the inadvertent entanglement of birds and bats; however, in addition to the added costs, bird guards may also reduce the numbers of target insects captured by the trap due to the physical blockage of visual attractors on the traps, and/or the particular landing activity of the target insects.

There remains a need for insect sticky traps that minimize or eliminate the bird/bat by-catch, improves the user experience in setting up the trap, and keep high trapping efficacy of the target insects. An adhesive insect trap that prevents or reduces the entrapment of nontarget species, and that allows the user to handle the trap without accidental contact with the adhesive feature of the trap, without requiring blocking guards or the like, is disclosed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An adhesive trap is disclosed that includes a corrugated panel defining a plurality of channels connected by convex peaks, the peaks having a width. A pressure sensitive adhesive is applied only to the plurality of channels, and the convex peaks of the corrugated panel are free of any adhesive.

In an embodiment the pressure-sensitive adhesive comprises a bead of adhesive, and in some embodiment the bead of adhesive defines an outward-facing planar surface.

In an embodiment the pressure-sensitive adhesive comprises a thin adhesive layer.

In an embodiment a linerboard is fixed along a face of the corrugated panel.

In an embodiment the plurality of channels have a height that is between 1/32 inches and ½ inches inclusive.

In an embodiment the corrugated panel comprises between 98 corrugations per meter and 433 corrugations per meter.

In an embodiment the corrugated panel comprises a tubular pillar, for example the tubular pillar may have a circular, hexagonal, triangular, or rectangular cross section.

In an embodiment the plurality of channels are parallel channels.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates corrugation pitch and height parameters for a corrugated panel, wherein the corrugated panel is shown with a linerboard;

FIGS. 2A, 2B, and 2C illustrate a portion of three embodiments of adhesive insect traps in accordance with the present invention, wherein a uniform thickness of an adhesive is provided only in valley or channel portions of the corrugations, and a protruding portion of each corrugation does not have any adhesive;

FIGS. 3A, 3B, and 3C illustrate a portion of three embodiments of adhesive insect traps in accordance with the present invention, wherein a non-uniform thickness of an adhesive is provided only in channels of the corrugations, and a protruding portion of each corrugation does not have any adhesive;

FIG. 4A illustrates a portion of an adhesive trap using as shown in FIG. 2C, with an insect captured by the adhesive trap;

FIG. 4B illustrates a portion of an insect captured by the adhesive insect trap shown in FIG. 3A;

FIG. 5A shows an adhesive trap in accordance with the present invention, formed as a flat panel;

FIG. 5B shows an adhesive trap in accordance with the present invention, formed or assembled as an upright circular cylinder;

FIG. 5C shows an adhesive trap in accordance with the present invention, formed or assembled as an upright hexagonal cylinder;

FIG. 5D shows an adhesive trap in accordance with the present invention, formed or assembled as an upright triangular cylinder; and

FIG. 5E shows an adhesive trap in accordance with the present invention, formed or assembled as an upright square cylinder.

### DETAILED DESCRIPTION

An adhesive trap configuration is disclosed that provides one or more corrugated surfaces or panels, wherein the adhesive panels are easier to handle and are less likely to entrap larger, non-target animals or to be damaged by inadvertent interaction with larger animals or the like. As used herein a corrugated panel (or corrugated sheet) is defined conventionally as a panel “shaped into wavy folds or alternating furrows and ridges” (see, www.dictiionary.com). The adhesive trap construction disclosed herein may be applied to a variety of pests, for example arthropods (e.g., insects), arachnids (e.g., spiders), reptiles, amphibians, small mammals (e.g., rats, mice, etc.), and the like, providing a new tool for combatting pestiferous and/or disease-vector critters.

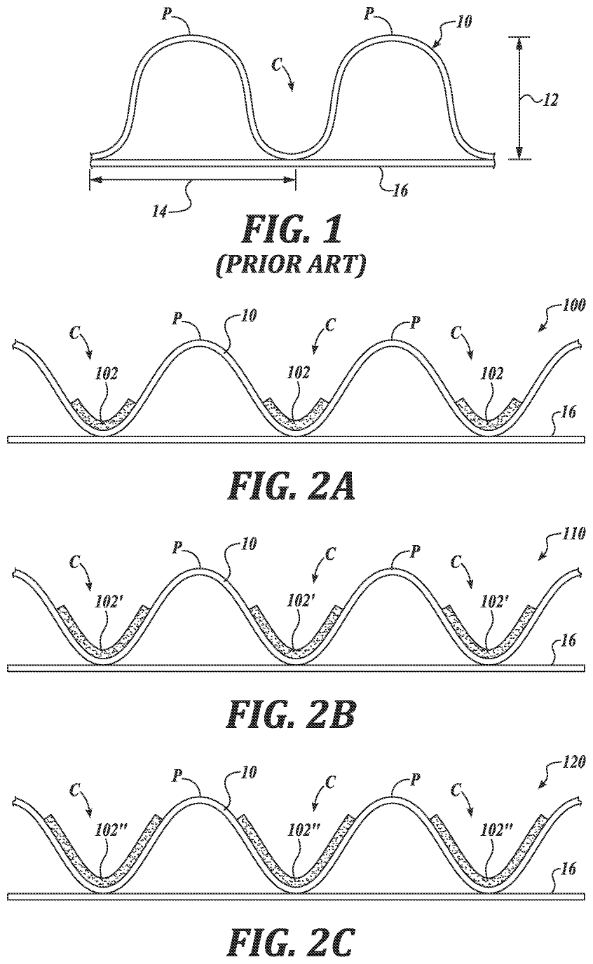

FIG. 1 is a schematic view illustrating a generic corrugated panel 10 defining a plurality of alternating ridges or peaks P (two shown) and grooves or channels C between adjacent peaks P. The channels C have a height 12 and a period or width 14. The corrugated panel 10 is shown optionally fixed to a linerboard 16, for example with an adhesive, fasteners, or the like. The linerboard 16 improves the structural rigidity of the corrugated panel 10.

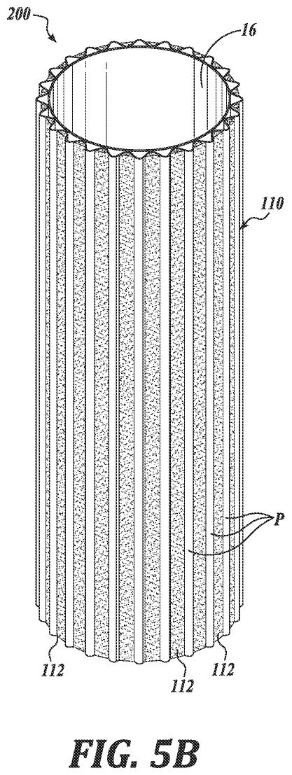

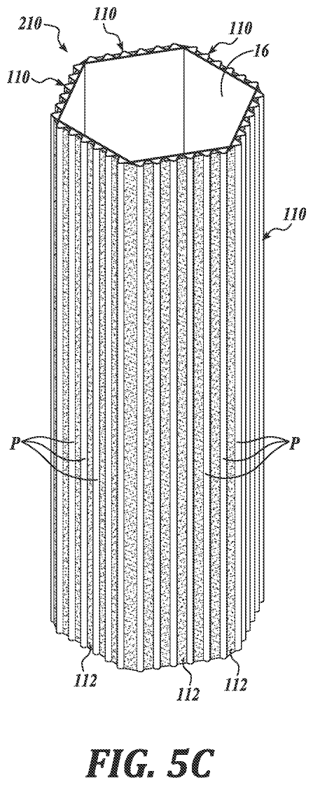

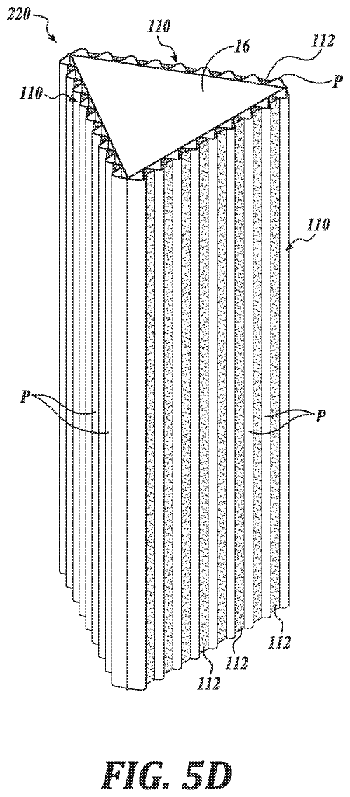

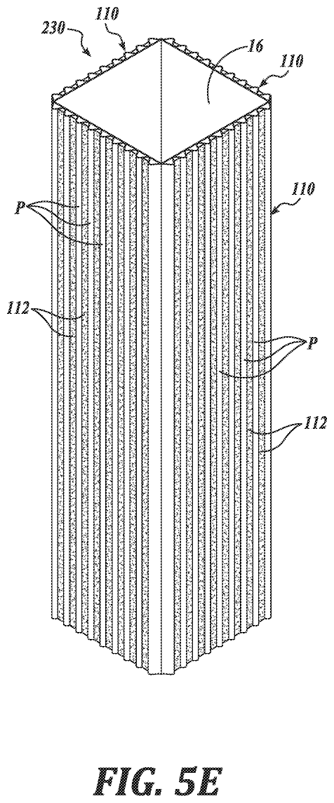

FIGS. 2A, 2B, and 2C are end views of three adhesive corrugated panel assemblies 100, 110, 120 respectively for an adhesive trap in accordance with the present invention. Examples of adhesive traps that may be constructed using any of these corrugated panels are shown in FIGS. 5A-5E. Each of the corrugated panel assemblies 100, 110, 120 include a corrugated panel 10 and an optional linerboard 16 fixed to the corrugated panel 10. The corrugated panel 10 is preferably made from relatively sturdy materials, for example fiberglass, plastic, or glass. In currently preferred embodiments the corrugation height 12 of the corrugated panel 10 is between 1/32 inches and ½ inches.

In FIG. 2A each of the channels C in the corrugated panel 10 has a strip of a pressure-sensitive adhesive material 102 provided as a thin adhesive layer, for example a glue, disposed generally along a center portion of the channel C. The adhesive material 102 preferably extends along most or all of the length of the associated channel C. The adhesive material 102 is applied or affixed to the channel C such that the adhesive material 102 extends to approximately one third the height 12 of the channel C, for example between 30% and 40% of the channel height 12. The adhesive material 102 may be applied to the channel C in any suitable manner. For example, the adhesive 102 may be sprayed onto the associated channel C, applied with a brush or roller, or adhered directly to the panel 10 as a double-sided sticky tape.

FIG. 2B illustrates a corrugated panel assembly 110 similar to the assembly 100 shown in FIG. 2A, including an adhesive material 102′ disposed generally along a centerline of the associated channel C, defining a thin adhesive layer. The adhesive material 102′ is approximately centered in the associated channel and in this embodiment extends laterally to approximately half the height 12 of the channel, for example between 45% and 55% of the channel height 12.

FIG. 2C illustrates a corrugated panel assembly 120 similar to the assembly 100 shown in FIG. 2A, including an adhesive material 102″ disposed generally along a centerline of the associated channel C in a thin adhesive layer. The adhesive material 102″ is approximately centered in the associated channel and in this embodiment extends laterally to approximately three quarters the height 12 of the channel C, for example between 70% and 80% of the channel height 12.

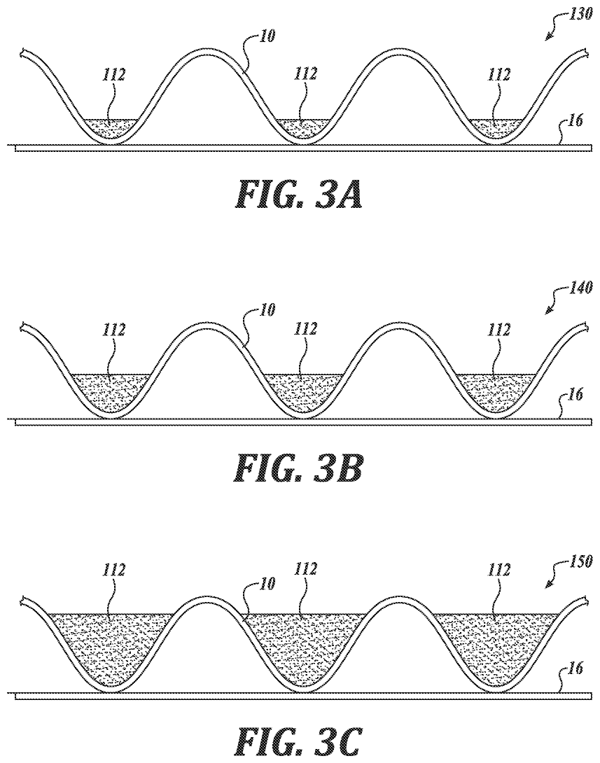

FIGS. 3A, 3B, and 3C show end views of three other embodiments of corrugated panel assemblies 130, 140, 150 respectively for an adhesive trap in accordance with the present invention, and except as discussed below are similar to the embodiments described above. In these embodiments, the adhesive material 112 is disposed generally along a centerline of the associated channel C and is applied such that the adhesive material 112 is a bead of adhesive that partially fills the associate channel C, defining a generally planar, outwardly-facing adhesive surface in the associated channel C, and between peak portions of the corrugated panel.

In FIG. 3A, the adhesive material 112 fills the associated channel to approximately one third the height 12 of the channel, for example between 30% and 40% of the channel height 12, and presents a generally flat, outwardly-facing adhesive face. In FIG. 3B, the adhesive material fills the associated channel to approximately half the height 12 of the channel C, for example between 45% and 55% the height of the channel, and defines a generally flat, outwardly-facing adhesive face. In FIG. 3C, the adhesive material fills the associated channel to approximately three-quarters the height 12 of the channel, for example between 70% and 80% of the channel height 12.

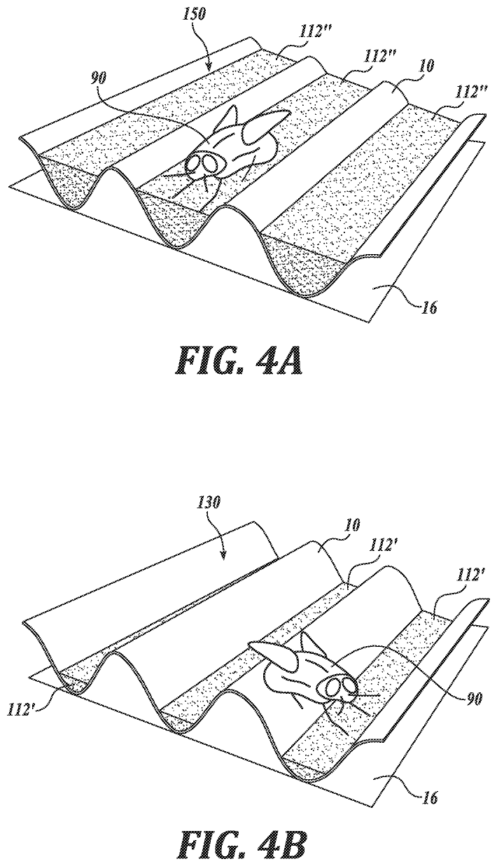

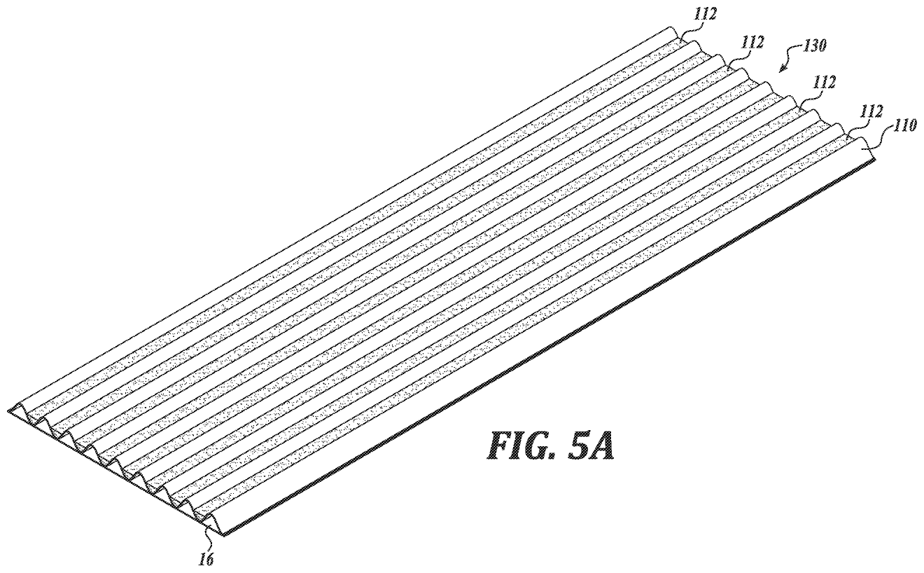

FIG. 4A is a perspective view of a portion of the corrugated panel assembly 150, and illustrating a pest 90 entrapped by the adhesive 112″. A target pest engaging the adhesive material 112″ similar to prior art adhesive pest devices such as fly paper and the like. Similarly, FIG. 4B illustrates a pest 90 entrapped by the adhesive 112′ of panel assembly 130. It will be appreciated that the a larger (non-target creature), for example, may engage the corrugated panel assemblies without becoming ensnared by the adhesive material recessed in the channels of the panel assemblies described above. Moreover, a person deploying, moving, or otherwise engaging with the adhesive panels may avoid direct contact with the adhesive material. The size and shape of the channels C in the corrugated panels, and type and quantity of adhesive provided in the channels C may be optimized for a particular application. Because the adhesive is provided only within the channels C, the outer perimeter of the corrugated flutes (i.e., ridges and grooves, see FIGS. 1-3) can be varied or adjusted for particular applications, for example depending on the size of the target insects and/or to avoid ensnaring non-target animals, such as birds, (with consideration of feather structures, perching behavior, and feet), bats, small rodents, and the like.

Optimal sizes and shapes of the corrugated flutes may also take into consideration typical human finger sizes to minimize user entanglement, as well as glue application requirements, coating area, etc. Common sizes of single-face corrugated flutes (paper cardboards) are A, B, C, E, and F flutes. Flute thickness (height), wavelength (pitch) as well as paper (or plastic) thickness for flutes and flat linerboard are variables that can be adjusted to be optimized for different target insects and/or applications. For sturdy plastic, glass or fiberglass corrugated surfaces, no linerboard is needed (see, FIG. 2; top). For example, a corrugated panel may be stood upright or hung with the adhesive applied in furrows on both sides of the panel; thus, the flute types and sizes for the single-face paper cardboards are contemplated for the more rigid materials without linerboard.

In some embodiments the corrugated panel is flexible, and configured to wrap around a fixed object, for example the base of a tree, or a movable object such as a movable container or post. For example, the corrugated panel may be formed as a flexible elongate panel, and configured to be installed as a spiraled wrap around the movable or fixed object. It is contemplated, for example, that a corrugated panel may include adhesive in the channels of both sides of the panel and wrapped around the base of the object. In some embodiments it may be preferable to install corrugated adhesive panels in alternating arrangements with adhesive applied on opposite sides of adjacent panels. The particular pattern of the adhesive placement may be configured to the specific behavioral characteristics of the pest targeted by the particular application.

In exemplary embodiments, the adhesive may be any pressure sensitive adhesive (“PSA”), or other type of glues that will adhesively ensnare a target insect. It is contemplated that the adhesive may be applied using (i) one or more spray heads (air spray or airless spray), (ii) wheel/roller systems, (iii) jetting systems, (iv) slot applicators/extruders, and/or (v) brush and/or trowel systems, for example. Other adhesive application systems as are known in the art may alternatively be used, including applying or printing narrow strips of adhesives or adhesive tapes into the furrows. In another embodiment an adhesive is applied to the entire surface and non-adhesive blocking strips are applied over the peaks of the corrugations that block the adhesive from adhering to the peaks.

In one method of making the adhesive trap with the desired glue area/thickness and patterns, glue is applied to the furrows in strips as a thin layer of adhesive membrane, e.g., thickness range from 1-40 mil, to cover a bottom ¼ to ½ or ¾ of the valley-ridge sloped surface area, in the grooves, leaving the corrugation top section (upper ridge section) with no adhesive. For example, the non-adhesive portions may comprise ¼ or more total corrugation area. In some embodiments, an adhesive may be applied as a thick bead having a diameter, for example, ⅓ to ½ or less of the groove height. Although uniform spacing of the corrugated surfaces are shown, it is contemplated that the corrugation spacing may be non-uniform. In some embodiments the ridge sections may be non-parallel, for example expanding in a fan-like arrangement.

Regardless of the corrugation types (sizes), the glue area along with the thickness of the glue in the groove should be sufficient to ensnare or capture target pests but restricted to the channels of the corrugated sheet or panel such that the corrugated panel may be handled by a user without contacting the adhesive directly, and to avoid or reduce the risk of contact by feathers or body parts of non-target creatures such as birds or bats. For example, the selected corrugation sizes or combination of corrugation sizes, and the glue area/thickness may be selected to engage multiple insect legs (at least 3) of a target insect no matter where the target insect lands on the corrugated surface.

It is contemplated that the corrugated or fluted panels may have color and/or pattern combinations providing a visual attractant for target insects, such as flies and/or social wasps. Examples of visual attractants on flat surfaces are disclosed in U.S. Pat. No. 9,015,988, to Zhang et al., which is hereby incorporated by reference in its entirety. It is believed that the three-dimensional characteristics of visual attractants on a corrugated surface will improve the efficacy of the attractant to target insects. In some embodiments the inner surface

FIG. 5A illustrates a panel structure 110 that may be formed using any of the embodiments shown in FIGS. 2A-2C or 3A-3C. In preferred embodiments the corrugated panel 100 has corrugations having a height between 1/32 inches and ½ inches, inclusive, and the corrugations are spaced to provide between 98 corrugations per meter and 433 corrugations per meter. A plurality of the panels 110 may be assembled or manufactured unitarily such as a hexagonal pillar 210 shown in FIG. 5C, a rectangular pillar 220 shown in FIG. 5D, a square pillar 230 shown in FIG. 5E. Non-corrugated pillar devices for insect visual attractant are disclosed, for example, U.S. Des. Pat. No. D700,269, to Chapin et al., which is hereby incorporated by reference in its entirety. It will be appreciated by persons of skill in the art that the target insects for adhesive insect traps may inform the placement of the adhesive.

In some embodiments the corrugated panel may be formed as an elongate flexible ribbon or tape that may be wrapped in a spiraling arrangement around an existing structure, for example a tree, fencepost, light post, power pole, or the like. For example, it is contemplated that spacers (not shown) may be fixed to an inner surface of the elongate flexible ribbon or tape, such that the flexible ribbon is spaced away from the structure, to provide access insect (or other pest) access to space between the structure and the ribbon. An adhesive applied only to the side of the flexible ribbon facing the structure would provide a non-adhesive outer face, and an inner surface that does not adhere to structure.

While illustrative embodiments have been shown and described, it will be appreciated that various changes can be made therein without departing from the spirit and scope of the invention.

The embodiments of the invention in which an exclusive property or privilege is claimed are defined as follows:

1. An adhesive trap for trapping small pests, the adhesive trap comprising:
a corrugated panel defining a plurality of channels connected by convex peaks having a width; and
a pressure sensitive adhesive adhered only to the plurality of channels, wherein the convex peaks of the corrugated panel are free of any adhesive.

2. The adhesive trap of claim 1, wherein the pressure-sensitive adhesive comprises a bead of adhesive.

3. The adhesive trap of claim 2, wherein the bead of adhesive defines an outward-facing planar surface.

4. The adhesive trap of claim 1, wherein the pressure-sensitive adhesive comprises a thin adhesive layer.

5. The adhesive trap of claim 1, further comprising a linerboard that is fixed along a face of the corrugated panel.

6. The adhesive trap of claim 1, wherein the plurality of channels have a height that is between 1/32 inches and ½ inches inclusive.

7. The adhesive trap of claim 1, wherein the corrugated panel comprises between 98 corrugations per meter and 433 corrugations per meter.

8. The adhesive trap of claim 1, wherein the corrugated panel comprises a tubular pillar.

9. The adhesive trap of claim 8, wherein the tubular pillar has a circular, hexagonal, triangular, or rectangular cross section.

10. The adhesive trap of claim 1, wherein the plurality of channels are parallel channels.

11. The adhesive trap of claim 1, wherein the corrugated panel is a tubular member.

12. The adhesive trap of claim 11, wherein the tubular member has a round, square, triangular, or hexagonal cross section.

13. An adhesive insect trap comprising:
at least one corrugated panel defining a plurality of channels that are connected by convex peaks such that the channels are spaced apart;
an adhesive disposed on at least a center portion of each of the channels;
wherein the convex peaks do not have any adhesive surface.

14. The adhesive insect trap of claim 13, wherein the at least one corrugated panel comprises a tube that is circular, triangular hexagonal, or square in cross section.
